(19) United States
(12) Patent Application Publication
(10) Pub. No.: US 2015/0002089 A1
(43) Pub. Date: Jan. 1, 2015

(54) CHARGING DEVICE FOR BATTERIES OF HAND-HELD TOOLS

(71) Applicants: Marcin Rejman, Waiblingen (DE); Volker Amann, Augsburg (DE); Juergen Mack, Goeppingen (DE); Freiderike Dietzel, Stuttgart (DE); Guenter Lohr, Leinfelden-Echterdingen (DE)

(72) Inventors: Marcin Rejman, Waiblingen (DE); Volker Amann, Augsburg (DE); Juergen Mack, Goeppingen (DE); Freiderike Dietzel, Stuttgart (DE); Guenter Lohr, Leinfelden-Echterdingen (DE)

(21) Appl. No.: 14/359,541

(22) PCT Filed: Nov. 7, 2012
(86) PCT No.: PCT/EP2012/072001

§ 371 Date: May 20, 2014

(30) Foreign Application Priority Data
Nov. 22, 2011 (DE) 10 2011 086 826.7

(51) Int. Cl. H02J 7/00; H02J 7/02

(52) U.S. Cl. CPC H02J 7/0045; H02J 7/025; H02J 7/0052; H02J 2007/0096
USPC 320/108

(57) ABSTRACT

A system includes: a hand-held tool battery, a hand-held tool battery charging device which has a battery accommodating area for accommodating the hand-held tool battery during an inductive charging operation, and a user interface which outputs an item of information about the charging operation.

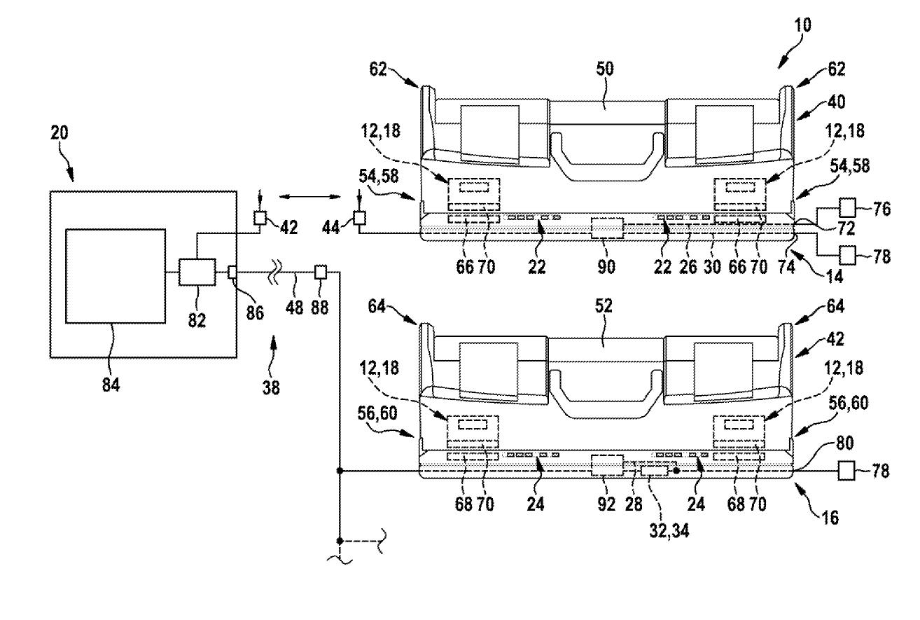

### BACKGROUND OF THE INVENTION

1. Field of the Invention

The present invention relates to a charging device for a battery of a hand-held tool.

2. Description of the Related Art

There has already been a proposal for a system including at least one hand-held tool battery and at least one hand-held tool battery charging device having at least one battery accommodating area, which accommodates at least the hand-held tool battery during an inductive charging operation.

### BRIEF SUMMARY OF THE INVENTION

The present invention is directed to a system including at least one hand-held tool battery and at least one hand-held tool battery charging device having at least one battery accommodating area, which accommodates at least the hand-held tool battery during an inductive charging operation.

It is proposed that the system has at least one user interface, which is provided to output at least one item of information regarding the charging operation. A “hand-held tool battery” should be understood in particular to be a rechargeable battery which is provided to supply power to a hand-held tool. The hand-held tool battery is preferably releasably connected to the hand-held tool, at least during operation without a tool in particular. Alternatively or additionally, a hand-held tool battery may be integrated into the hand-held tool. The hand-held tool battery in particular supplies at least 5 watts, preferably at least 25 watts, particularly preferably at least 100 watts during at least one operating state. The hand-held tool battery in particular supplies at least 2.5 watt hours, particularly advantageously at least 5 watt hours, particularly advantageously at least 10 watt hours.

A “hand-held tool” should be understood in particular to be a portable tool which appears appropriate to those skilled in the art but is advantageously a drill, a drill hammer, a percussion hammer, a saw, a plane, a screwdriver, a milling machine, a grinder, an angle grinder, a gardening tool, a construction site measuring device and/or a multifunction tool. A “hand-held tool battery charging device” in particular should be understood to be a device which transfers a charging power to the hand-held tool battery during a charging operation. The system advantageously has multiple hand-held tool battery charging devices. The hand-held tool battery charging device preferably attaches, particularly preferably positions, the hand-held tool battery directly, or in particular preferably indirectly, via a hand-held tool case. The hand-held tool battery charging device preferably has an electronic charger. An “electronic charger” should be understood in particular to be an electronic unit, which controls and/or preferably regulates the transfer of power to the hand-held tool battery as a function of a charge state of the hand-held tool battery. The hand-held tool battery preferably requests a charging power from the electronic charger.

A “battery accommodating area” should be understood in particular to be an area in which the hand-held tool battery is situated at least during a charging operation. The hand-held tool battery charging device preferably attaches and/or positions the hand-held tool battery directly or advantageously indirectly in the battery accommodating area during a charging operation. Alternatively or additionally, the hand-held tool battery charging device may have a display, a mold, a fastening means and/or preferably a mark which defines the battery accommodating area in particular. An “inductive charging operation” should be understood in particular to refer to an operation in which the hand-held battery charging device charges the hand-held tool battery via a charging power transferred with the aid of magnetic fields from the hand-held battery charging device to the hand-held battery. In particular the hand-held battery charging device and the hand-held battery do not have any electrically conductive connection transferring a charging power.

A “user interface” should be understood in particular to be a unit which is provided for acoustic, haptic and/or advantageously visual output of information to a user. The user interface preferably has at least one light source, preferably at least one light-emitting diode, in particular preferably a display for displaying the information. The user interface advantageously has at least one input means for receiving user input. The user interface is advantageously provided to output information about a position of the hand-held tool battery, a charging state of the hand-held tool battery, information about a temperature of the hand-held tool battery or of the hand-held tool battery charging device, interference, efficiency of the charging operation, an ambient temperature, an age, a capacitance, a type of hand-held tool battery and/or use information about the hand-held tool battery.

The user interface is preferably provided to receive user input for the selection of a charging curve, in particular for a fast charge, a charge with the greatest possible capacitance, a charge for a maximum lifetime and/or a prioritization of a charge of a hand-held tool battery in one of multiple hand-held tool battery charging devices. The user interface is preferably designed as an independent module, as a module integrated into the hand-held tool battery charging device and/or as a module or software integrated at least partially into an on-board computer in a motor vehicle, a mobile telephone and/or a computer. The user interface may advantageously be integrated into the hand-held tool battery of the system. Information such as a number of charging cycles, an age-dependent capacitance, a production date, a date of initial use, a display of a charge state and a position in the battery accommodating area may therefore be displayed independently by the hand-held tool battery charging device.

“Information about a position of the hand-held tool battery” should preferably be understood to include at least one item of information indicating whether inductive charging of the hand-held tool battery is possible in the instantaneous position relative to the hand-held tool battery charging device with at least a certain efficiency in particular. The term “provided” should be understood in particular to mean specially programmed, designed and/or equipped. “Information about the charging operation” should be understood in particular to refer at least to one item of information about a characteristic variable which influences the charging operation and/or which changes during a charging operation. The information about the charging operation is preferably an item of information which appears appropriate to those skilled in the art, but is preferably an item of information such as how much power the hand-held tool battery stores and/or an item of information about the quality of an inductive transfer. The user interface is preferably provided to output multiple items of different information in particular from one or advantageously multiple hand-held tool batteries. Due to the design of the system according to the present invention, the user is able, after placing the hand-held tool battery in the battery accommodating area, to check advantageously on whether the hand-held tool battery is situated in a position compatible with inductive charging of the hand-held tool battery.

In another embodiment, it is proposed that the system has a first power supply unit and a second power supply unit, so that in the event of an outage, non-availability and/or a shutdown of a power supply of the first power supply unit, it is possible to resort to a power supply of the second power supply unit. Power consumption may be minimized in particular in the event of an outage, non-availability and a shutdown of a power supply by making available only some of the functions of the system in particular. The hand-held tool battery charging device preferably has at least one of the power supply units, advantageously both power supply units. Alternatively, the user interface may have at least one of the power supply units, advantageously both power supply units. In another alternative, a power supply device of the system, which is designed as a separate module in particular, may have at least one of the power supply units.

A “power supply unit” should be understood in particular to be a unit, which is provided to make available power coming from a power supply for a function in particular. The function is preferably different from storing information. The power supply units preferably supply power for different functions in at least one operating state. The first power supply unit preferably supplies power at least for the user interface. Preferably only the second power supply unit supplies power for charging the hand-held tool battery. In particular the power supply units each have their own power input which is connected in particular to their own power supply.

Alternatively, the power supply units may have a shared power input and may have separate power paths downstream from the power input. The first power supply unit is preferably connected to a permanent power supply of a motor vehicle. The second power supply unit is preferably connected to a temporarily interrupted power supply of the motor vehicle; this power supply depends in particular on an ignition of the motor vehicle. In particular the system has a sensor, which detects non-availability of the power supply. The sensor preferably detects whether an engine of the vehicle is running.

In addition, it is proposed that the first power supply unit supplies power for detecting the position of the hand-held tool battery at least during an interruption in the power supply of the second power supply unit, so that the user is advantageously able to position the hand-held tool battery even during the interruption in the power supply. In particular, the hand-held tool battery may also be charged directly and reliably after the interruption in the power supply because the user has already been able to verify the positioning of the hand-held tool battery. In particular, an “interruption in the power supply” should be understood to refer to a state in which a power supply of the second power supply unit is unable to deliver power. In particular, the power supply does not supply any input voltage during an interruption in the power supply of the second power supply unit.

The phrase “supply power” should be understood to mean that the first power supply unit supplies power to a function when the second power supply unit is unable to supply power to the function because of an interruption in the power supply. In particular the phrase “for detection of the position of the hand-held tool battery” should be understood to mean that the hand-held tool battery charging device has at least one electronic charger, which ascertains a characteristic variable which depends on a configuration of the hand-held tool battery relative to the hand-held tool battery charging device in at least one operating state and preferably outputs it to a user. The electronic charger preferably ascertains at least whether the hand-held tool battery is situated in a position required for inductive charging. The electronic charger preferably detects a characteristic variable, which at least has an item of information which is dependent on the distance of the hand-held tool battery from the required position.

Furthermore, it is proposed that the first power supply unit supplies power for output of the information of the charging operation, at least in the case of an interruption in the power supply of the second power supply unit, so that this information is advantageously available to the user even during the interruption in the power supply. The phrase “supply power for output of information of the charging operation” should be understood in particular to mean that the first power supply unit delivers power during the interruption in the power supply, with the aid of which the user interface transmits the information about the charging operation to the user.

Furthermore, it is proposed that the first power supply unit has at least one energy store, so that operation of the two power supply units via one power supply is advantageously possible. In particular, an “energy store” should be understood to be a rechargeable battery, a capacitor and/or some other store which appears appropriate to those skilled in the art and is large enough to detect the position of the hand-held tool battery and in particular the output of the information about the charging operation over a period of at least one minute. Alternatively or additionally, the power supply unit may be provided to draw power from the hand-held tool battery at least temporarily.

In addition, it is proposed that the system includes a separation unit, which is provided to electrically connect the hand-held tool battery charging device and the user interface at a distance from one another, whereby it is possible to monitor the position and a charge state of the hand-held tool battery at a site different from the storage site. The hand-held tool battery charging device may in particular be situated in a charging area of a motor vehicle and the user interface may be situated in a cab of the motor vehicle, so that the position and the charge state may be monitored by the driver, in particular while driving. A “separation unit” should be understood in particular to be a unit which is provided to transmit at least one item of information from the hand-held tool battery charging device to the user interface, which is situated at a distance from the hand-held tool battery charging device. The separation unit preferably has a cable connecting the hand-held tool battery charging device and the user interface, this cable being longer than 1 m in particular, advantageously longer than 3 m. Alternatively and/or additionally, the separation unit may have a wireless data transmission link, which is suitable at least for bridging at least this distance. The phrase “situated at a distance from one another” should be understood in particular to mean that there is a distance of at least 1 m, advantageously 3 m, between each point on the hand-held tool battery charging device and each point on the user interface. Alternatively or additionally, the system could have a user interface which is situated in proximity to, i.e., less than 1 m away from, the hand-held tool battery charging device. “Electrically connecting” should be understood in particular to mean at least a data transmission via an electrically conductive and/or electromagnetic path.

In one advantageous embodiment of the present invention, it is proposed that the user interface is provided in particular to communicate with multiple hand-held tool battery charging devices, so that a flexibly expandable system may be made available. In particular the phrase “communicate with multiple hand-held tool battery charging devices” should be understood to mean that the user interface has multiple communication means, which are provided to communicate with one hand-held tool battery charging device at a time. The communication means are preferably each designed to be at least partially in one piece, for example, as the communication means of a databus, which is provided to communicate with multiple hand-held tool battery charging devices.

Furthermore, it is proposed that the hand-held battery charging device has a case accommodating area, which overlaps at least partially with the battery accommodating area in particular, so that a hand-held tool battery situated in a hand-held tool case may be charged. A “case accommodating area” should be understood in particular to be an area of the hand-held tool battery charging device, in which a hand-held tool case of the system is situated at least during a charging operation. The hand-held tool battery charging device preferably has at least one fastening device for fastening the hand-held tool case in the case accommodating area. A charging device housing of the hand-held tool battery charging device preferably delimits the case accommodating area on at least one side. In particular, a “hand-held tool case” should be understood to refer to a case, which, when closed, delimits a tool accommodating area in a shock-proof, moisture-proof and/or dust-proof manner. The hand-held tool case is preferably provided to situate the hand-held tool battery in the battery accommodating area of the hand-held tool battery charging device and/or to secure it advantageously. The hand-held tool case preferably delimits the tool accommodating area at least partially in the form of a hand-held tool battery. The hand-held tool case preferably has at least one positioning and/or fixation means for positioning and/or fixation of a hand-held tool, a hand-held tool having a connected hand-held tool battery and/or particularly preferably a hand-held tool battery. The hand-held tool case is preferably magnetically passive and/or advantageously electrically passive. The hand-held tool case does not have an electrical system in particular. Alternatively or additionally, the hand-held tool case could have a charging coil and/or advantageously a magnetic field conductor, which receives the power and relays it magnetically and/or in a hard-wired manner to a hand-held tool battery. The hand-held tool case is preferably designed according to the hand-held tool case described in the publication DE 10 2008 058 007 B3, but it has a hand-held tool accommodating area and/or a hand-held tool battery accommodating area, which is provided for accommodating an inductively chargeable hand-held tool battery during a charging operation. The term “overlap” in this context should be understood in particular to mean that the battery accommodating area is situated at least partially, preferably completely, in the case accommodating area.

Furthermore, it is proposed that the system includes at least one communication means, which is provided for wireless communication, whereby a data line and in particular its installation may be dispensed with. A “communication means” should be understood to be in particular the means which are provided for at least transmitting information and/or preferably exchanging information. The hand-held tool battery charging device and the user interface preferably each have a communication means. The phrase “wireless communicating” should be understood in particular to mean that the communication means is provided for transmitting an item of information via an advantageously nonphysical information carrier, for example, via sound waves, light waves and/or preferably radio waves. The communication means preferably transmits the signal through at least one electrical insulator, which is situated in particular between a transmitter and a receiver, for example, an electrically nonconductive plastic and/or air. The communication means preferably transmits the information over a distance of more than 50% of the total distance of the communication through the insulator. The communication means is provided in particular for communication via a wireless connection, which appears appropriate to those skilled in the art, but preferably via a mobile radio network such as GSM, a Bluetooth connection, an ISM connection and/or a WLAN connection.

In addition, it is proposed that the user interface is provided to communicate with the hand-held tool battery charging device via an electrical system of a motor vehicle, whereby a particularly reliable communication may be achieved in a structurally simple manner. An “electrical system of a motor vehicle” should be understood to refer in particular to a network which appears appropriate to those skilled in the art, preferably a LIN bus, a FlexRay bus and/or a CAN bus. Alternatively, the user interface may communicate with the hand-held tool battery charging device via a LAN and/or USB.

### BRIEF DESCRIPTION OF THE DRAWING

The FIGURE illustrates an exemplary embodiment of the present invention.

### DETAILED DESCRIPTION OF THE INVENTION

The figure shows a system 10 having four hand-held tool batteries 12, a first and a second hand-held tool battery charging device 14, 16, a first user interface 20, a separation unit 38 and two hand-held tool cases 50, 52. Hand-held tool battery charging devices 14, 16 each have holding devices 54, 56, each of which secures one of hand-held tool cases 50, 52 in a case accommodating area 40, 42 of respective hand-held tool battery charging device 14, 16. Holding devices 54, 56 lock hand-held tool cases 50, 52 in place. Hand-held tool cases 50, 52 each have first holding devices 58, 60, which couple to holding devices 54, 56 of hand-held tool battery charging devices 14, 16 in at least one operating state. Hand-held tool cases 50, 52 have second holding devices 62, 64, which are designed according to holding devices 54, 56 of hand-held tool battery charging devices 14, 16. Thus, second holding devices 62, 64 of hand-held tool cases 50, 52 are provided for coupling to a first holding device 58, 60 of another hand-held tool case 50, 52 and for forming a stack.

During a charging operation, hand-held tool cases 50, 52 position hand-held tool batteries 12 in battery accommodating areas 18 of hand-held tool battery charging devices 14, 16 in their interior. Case accommodating areas 40, 42 and battery accommodating areas 18 thus partially overlap. Hand-held tool battery charging devices 14, 16 have charging coils 66, 68, situated adjacent to battery accommodating areas 18. Battery accommodating areas 18 accommodate hand-held tool batteries 12 during the inductive charging operation. Charging coils 66, 68 of hand-held tool battery charging devices 14, 16 inductively transmit a charging power to charging coils 70 of hand-held tool batteries 12 during a charging operation. Charging coils 66, 68 of hand-held tool battery charging devices 14, 16 transmit the charging power through a case wall of respective hand-held tool case 50, 52 to corresponding hand-held tool batteries 12.

Hand-held tool battery charging devices 14, 16 each have two user interfaces 22, 24, one of which outputs an item of information about a position of hand-held tool battery 12 relative to a position having an optimal inductive coupling between charging coils 66, 68, 70 on introducing one of hand-held tool batteries 12 into one of battery accommodating areas 18. In addition, hand-held tool battery charging devices 14, 16 each have a proximity sensor, which initiates detection of hand-held tool battery 12 and output of the information, at least when a user approaches hand-held tool battery charging devices 14, 16. When hand-held tool battery 12 is situated in battery accommodating area 18, respective user interface 22, 24 outputs a charge state of hand-held tool battery 12. During the charging operation of hand-held tool battery 12, user interface 22, 24 outputs an instantaneous charge state of the charging operation of corresponding hand-held tool battery 12.

First and second hand-held tool battery charging devices 14, 16 each have a first power supply unit 26, 28 and a second power supply unit 30, 32. In the event of an interruption in the power supply of second power supply units 30, 32, first power supply units 26, 28 each supply power for the detection and output of a position and a charge state of hand-held tool batteries 12. During the charging operation, second power supply units 30, 32 make available a power for the charging operation of hand-held tool batteries 12.

First hand-held tool battery charging device 14 has a first power input 72 and a second power input 74 separate from first power input 72. A first power supply 76 is connected to first power supply unit 26 via first power input 72. First power supply 76 is designed as a permanent power supply 76 of a motor vehicle (not shown in detail) in which system 10 is installed. A second power supply 78 is connected via second power input 74 to second power supply unit 30. Second power supply 78 is designed as a power supply 78, which is active only when the ignition has been activated and/or the engine of the motor vehicle is running.

Second hand-held tool battery charging device 16 has a power input 80, which is connected to both power supply units 28, 32. Power input 80 of second hand-held tool battery charging device 16 is connected to second power supply 78. First power supply unit 28 has an energy store 34. Energy store 34 buffers the power for detection and output of a position and a charge state of hand-held tool battery 12. During a charging operation, a second power supply unit 32 makes power available directly for the charging operation, whereby a high efficiency is achievable. Alternatively, power for a charging operation could be made available via a buffer, and a charging operation could advantageously be interrupted in the absence of a power supply from an electronic charger.

First user interface 20 is situated in the cab of the motor vehicle. User interface 20 includes a computation unit 82 and a display 84. Display 84 is designed as a touch-sensitive display 84. Display 84 outputs information about positions and charge states of hand-held tool batteries 12. Display 84 informs a driver of the motor vehicle, for example, when one of hand-held tool batteries 12 is no longer in a position suitable for the charging operation during a trip.

Separation unit 38 has four communication means 44, 46, 86, 88. Communication means 44, 46, 86, 88 are designed as retrofit modules. Alternatively, communication means may be integrated into a user interface or a hand-held tool battery charging device. A first one of communication means 44 is connected to computation unit 82 of first user interface 20 via an interface which appears appropriate to those skilled in the art. A second one of communication means 46 is connected to a computation unit 90 of first hand-held tool battery charging device 14. A third one of communication means 86 is connected to computation unit 82 of first user interface 20. A fourth one of communication means 88 is connected to a computation unit 92 of second hand-held tool battery charging device 16. Separation unit 38 thus electrically connects hand-held tool battery charging devices 14, 16 and first user interface 20 which are situated at a distance from one another. During operation, user interface 20 communicates via separation unit 38 with both first and second hand-held tool battery charging devices 14, 16.

First and second communication means 44, 46 are provided for wireless communication with one another. First and second communication means 44, 46 communicate via a radio connection, specifically an ISM radio connection. These means transmit information between computation unit 82 of first user interface 20 and computation unit 90 of first hand-held tool battery charging device 14. Third and fourth communication means 86, 88 are provided for communicating with hand-held tool battery charging device 16 via an electrical system 48 of the motor vehicle. They transmit information between computation unit 82 of first user interface 20 and computation unit 92 of second hand-held tool battery charging device 16. Third communication means 86 is integrated into first user interface 20.

1-13. (canceled)

14. A system comprising:
at least one hand-held tool battery;
at least one hand-held tool battery charging device having at least one battery accommodating area which accommodates at least the hand-held tool battery during an inductive charging operation; and
at least one user interface for outputting at least one item of information of the charging operation.

15. The system as recited in claim 14, further comprising a first power supply unit and a second power supply unit.

16. The system as recited in claim 15, wherein the first power supply unit supplies power for detecting the position of the hand-held tool battery during an interruption in a power supply of the second power supply unit.

17. The system as recited in claim 15, wherein the first power supply unit supplies power for output of the at least one item of information of the charging operation at least during an interruption in a power supply of the second power supply unit.

18. The system as recited in claim 15, wherein the first power supply unit has at least one energy store.

19. The system as recited in claim 15, further comprising a separation unit provided to electrically connect the hand-held tool battery charging device and the at least one user interface at a distance from one another.

20. The system as recited in claim 15, wherein the at least one user interface communicates with multiple hand-held tool battery charging devices.

21. The system as recited in claim 15, wherein the at least one hand-held tool battery charging device has a case accommodating area which overlaps at least partially with the at least one battery accommodating area.

22. The system as recited in claim 15, further comprising:
at least one communication unit provided for wireless communication.

23. The system as recited in claim 15, wherein the at least one user interface communicates with the hand-held tool battery charging device via an electrical system of a motor vehicle.
